(19) United States
(12) Patent Application Publication
(10) Pub. No.: US 2017/0248213 A1
(43) Pub. Date: Aug. 31, 2017

(54) PLANETARY POWERTRAIN CONFIGURATIONS WITH A BALL VARIATOR CONTINUOUSLY VARIABLE TRANSMISSION USED AS A POWERSPLIT

(71) Applicant: Dana Limited, Maumee, OH (US)

(72) Inventors: Sebastian J. Peters, Cedar Park, TX (US); Travis J. Miller, Cedar Park, TX (US)

(21) Appl. No.: 15/440,220

(22) Filed: Feb. 23, 2017

Related U.S. Application Data
(60) Provisional application No. 62/301,233, filed on Feb. 29, 2016.

(51) Int. Cl. F16H 37/08; F16H 3/66; F16H 15/50

(52) U.S. Cl. CPC F16H 37/086; F16H 15/503; F16H 3/66; F16H 2037/088; F16H 2200/201; F16H 2200/2064; F16H 2200/2094

(57) ABSTRACT

Devices and methods are provided herein for the transmission of power in motor vehicles. Power is transmitted in a smoother and more efficient manner by splitting torque into two or more torque paths. A continuously variable transmission is provided with a ball variator assembly having two arrays of balls, a planetary gearset coupled thereto and an arrangement of rotatable shafts with multiple gears and clutches that extend the ratio range of the variator. In some embodiments, clutches are coupled to the gear sets to enable synchronous shifting of gear modes.

### RELATED APPLICATION

The present application claims priority to and the benefit from Provisional U.S. Patent Application Ser. No. 62/301,233 filed on Feb. 29, 2016. The content of the above-noted patent application is hereby expressly incorporated by reference into the detailed description of the present application.

### BACKGROUND

A driveline including a continuously variable transmission allows an operator or a control system to vary a drive ratio in a stepless manner, permitting a power source to operate at its most advantageous rotational speed.

### SUMMARY

Provided herein is a continuously variable transmission (CVT) including: a first rotatable shaft operably coupleable to a source of rotational power; a second rotatable shaft aligned substantially coaxial to the first rotatable shaft, the first rotatable shaft and second rotatable shaft forming a main axis of the transmission; a third rotatable shaft aligned substantially parallel to the main axis; a first variator assembly having a first traction ring assembly and a second traction ring assembly in contact with a first plurality of balls, each ball having a tiltable axis of rotation; wherein the first variator assembly is coaxial with the main axis, the first traction ring assembly is coupled to the second rotatable shaft; a second variator assembly having a third traction ring assembly and a fourth traction ring assembly in contact with a second plurality of balls, each ball having a tiltable axis of rotation; wherein the second variator assembly is coaxial with the main axis, the third traction ring assembly is coupled to the second traction ring assembly; a first planetary gearset having a first sun gear, a first planet carrier, and a first ring gear; wherein the first sun gear is coupled to the second rotatable shaft, the first ring gear is coupled to the fourth traction ring assembly, and the first planet carrier is operably coupled to the first rotatable shaft; a second planetary gear set arranged coaxial with the third rotatable shaft, the second planetary gear set having a second sun gear, a second planet carrier, and a second ring gear; wherein the second planet carrier is operably coupled to the first rotatable shaft; a third planetary gear set arranged coaxial with the third rotatable shaft, the third planetary gear set having a third sun gear, a third planet carrier, and a third ring gear; wherein the third planet carrier is grounded; a forward clutch positioned coaxial with the third rotatable shaft, the forward clutch operably coupled to the second sun gear and the third sun gear; and a reverse clutch operably coupled to the second sun gear and the third sun gear.

Provided herein is a vehicle driveline including a power source, a variable transmission of any of described herein drivingly engaged with the power source, and a vehicle output drivingly engaged with the variable transmission.

Provided herein is a vehicle including the variable transmission of any one of the transmissions described herein.

Provided herein is a method including providing a variable transmission of any one of the transmissions described herein.

Provided herein is a method including providing a vehicle driveline of the kind described herein.

Provided herein is a method including providing a vehicle having any one of the transmission described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present embodiments will be obtained by reference to the following detailed description that sets forth illustrative embodiments, in which the principles of the embodiments are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a schematic diagram of a planetary power split continuously variable transmission.

FIG. 5 is a table depicting operating modes of the continuously variable transmissions depicted in FIG. 4.

### DETAILED DESCRIPTION OF THE EMBODIMENTS

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the embodiments include several novel features, no single one of which is solely responsible for its desirable attributes or which is essential to practicing the embodiments described.

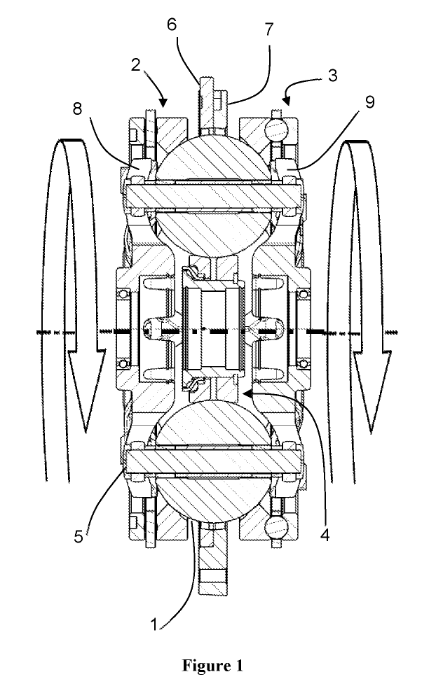

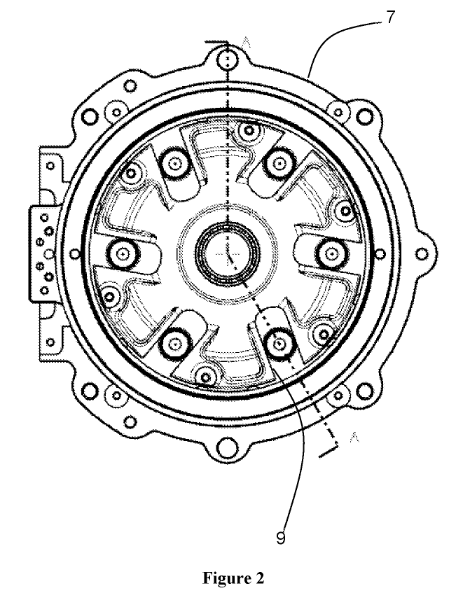

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input traction ring 2, an output traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, but are slightly different.

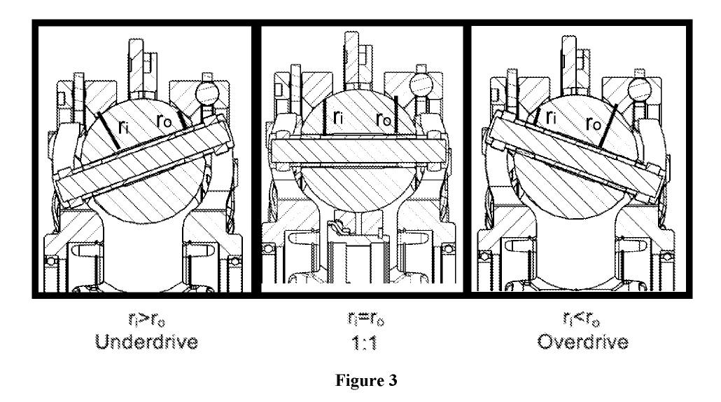

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

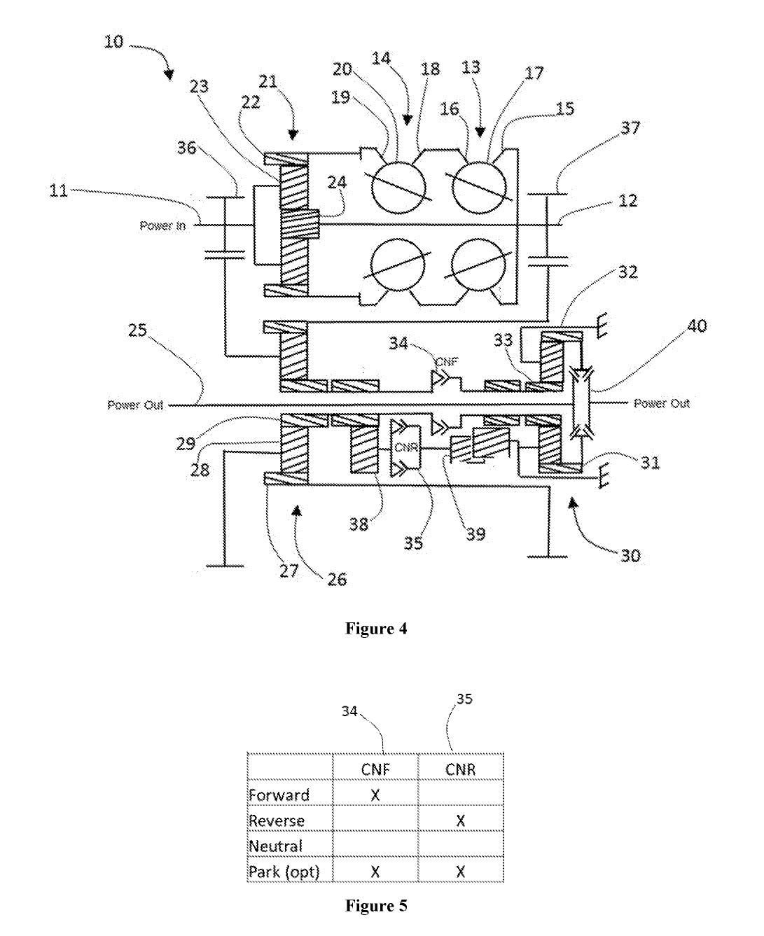

Referring now to FIG. 4, in some embodiments, a continuously variable transmission (CVT) 10 is provided with a first rotatable shaft 11 adapted to receive power from a source of rotational power. In some embodiments, the CVT 10 has a second rotatable shaft 12 coaxial with the first rotatable shaft 11. The first rotatable shaft 11 and the second rotatable shaft 12 form a main axis of the CVT 10. The CVT 10 has a first variator assembly 13 arranged coaxial with the main axis. The CVT 10 has a second variator assembly 14 arranged coaxial with the main axis. In some embodiments, the first variator assembly 13 and the second variator assembly 14 are each configured to be a CVP of the type depicted in FIGS. 1-3. In some embodiments, the first variator assembly 13 has a first traction ring assembly 15 and a second traction ring assembly 16 coupled to a first plurality of balls 17. In some embodiments, the second variator assembly 14 has a third traction ring assembly 18 and a fourth traction ring assembly 19 coupled to a second plurality of balls 20. In some embodiments, the first traction ring assembly 15 is coupled to the second rotatable shaft 12. The second traction ring assembly 16 is coupled to the third traction ring assembly 18. In some embodiments, the CVT 10 is provided with a first planetary gear set 21 arranged coaxial with the main axis. The first planetary gear set 21 includes a first ring gear 22, a first planet carrier 23, and a first sun gear 24. In some embodiments, the fourth traction ring assembly 19 is coupled to the first ring gear 22. The first planet carrier 23 is coupled to the first rotatable shaft 11. The first sun gear 24 is coupled to the second rotatable shaft 12.

Still referring to FIG. 4, in some embodiments, the CVT 10 is provided with a third rotatable shaft 25 aligned parallel to the main axis. The CVT 10 has a second planetary gear set 26 arranged coaxial with the third rotatable shaft 25. The second planetary gear set 26 includes a second ring gear 27, a second planet carrier 28, and a second sun gear 29. The CVT 10 has a third planetary gear set 30 arranged coaxial with the third rotatable shaft 25. The third planetary gear set 30 includes a third ring gear 31, a third planet carrier 32, and a third sun gear 33. In some embodiments, the third planet carrier 32 is grounded to a non-rotatable member of the CVT 10 such as a housing (not shown). In some embodiments, the CVT 10 includes a forward synchronizer clutch 34 and a reverse synchronizer clutch 35. The forward synchronizer clutch 34 is coaxial with the third rotatable shaft 25. The reverse synchronizer clutch 35 is operably coupled to, and arranged parallel with, the third rotatable shaft 25. The forward synchronizer clutch 34 is operably coupled to the second sun gear 29 and the third sun gear 33.

Typically, synchronizer mechanisms (referred to herein as “synchronizer clutch”) used in power transmissions include a dog clutch integrated with a speed-matching device such as a cone-clutch. During operation of the transmission, if the dog teeth of the dog clutch make contact with a gear, and the two parts are spinning at different speeds, the teeth will fail to engage and a loud grinding sound will be heard as they clatter together. For this reason, a synchronizer mechanism or synchronizer clutch is used, which consists of a cone clutch. Before the teeth engage, the cone clutch engages first, which brings the two rotating elements to the same speed using friction. Until synchronization occurs, the teeth are prevented from making contact. It should be appreciated that the exact design of the synchronizer clutch is within a designer's choice for satisfying packaging and performance requirements. A synchronizer clutch is optionally configured to be a two position clutch having an engaged position and a neutral (or free) position. A synchronizer clutch is optionally configured to be a three position clutch having a first engaged position, a second engaged position, and a neutral position. Embodiments disclosed herein use synchronizer clutches to enable the pre-selection of gear sets by a control system (not shown) for smooth transition between operating modes of the transmission.

Still referring to FIG. 4, in some embodiments, the CVT 10 has a first gear set 36 configured to couple the first rotatable shaft 11 to the second planet carrier 28. In some embodiments, the CVT 10 has a second gear set 37 configured to couple the second rotatable shaft 12 to the second ring gear 27. In some embodiments, the CVT 10 has a third gear set 38 configured to couple the second sun gear 29 to the reverse synchronizer clutch 35. In some embodiments, the CVT 10 has a fourth gear set 39 configured to couple the reverse synchronizer clutch 35 to the third sun gear 33. It should be appreciated that the first gear set 36, the second gear set 37, the third gear set 38, and the fourth gear set 39 are optionally configured to be chain drives having chain driving sprockets. In some embodiments, the CVT 10 includes a final drive gear 40 couple to the third ring gear 31. The final drive gear 40 is adapted to transfer power out of the CVT 10.

Referring now to FIG. 5, during operation of some embodiments of the CVT 10, a forward mode of operation corresponds to the selective engagement of the forward synchronizer clutch 34 and the disengagement of the reverse synchronizer clutch 35. A reverse mode of operation corresponds to the selective engagement of the reverse synchronizer clutch 35 and the disengagement of the forward synchronizer clutch 34. A neutral mode of operation corresponds to the disengagement of the forward synchronizer clutch 34 and disengagement of the reverse synchronizer clutch 35. A park mode of operation corresponds to the simultaneous engagement of both the forward synchronizer clutch 34 and the reverse synchronizer clutch 35.

Provided herein is a vehicle driveline including a power source, a variable transmission of any of described herein drivingly engaged with the power source, and a vehicle output drivingly engaged with the variable transmission. In some embodiments of the vehicle driveline, the power source is drivingly engaged with the vehicle output.

Provided herein is a vehicle including the variable transmission of any one of the transmissions described herein.

Provided herein is a method including providing a variable transmission of any one of the transmissions described herein.

Provided herein is a method including providing a vehicle driveline of the kind described herein.

Provided herein is a method including providing a vehicle having any one of the transmission described herein. In some embodiments, the method further includes engaging the reverse clutch to operate in a reverse mode. In some embodiments, the method further includes engaging the forward clutch to operate in a forward mode. In some embodiments, the method further includes engaging the forward clutch and the reverse clutch to operate in a park mode. In some embodiments, the method further includes disengaging the forward clutch and the reverse clutch to operate in a neutral mode.

It should be noted that the description above has provided dimensions for certain components or subassemblies. The mentioned dimensions, or ranges of dimensions, are provided in order to comply as best as possible with certain legal requirements, such as best mode. However, the scope of the disclosure described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments described herein may be employed in practicing the disclosure. It is intended that the following claims define the scope of the disclosure and that methods and structures within the scope of these claims and their equivalents be covered thereby.

What is claimed is:

1. A continuously variable transmission comprising:
a first rotatable shaft operably coupleable to a source of rotational power;
a second rotatable shaft aligned coaxial to the first rotatable shaft, the first rotatable shaft and second rotatable shaft forming a main axis of the transmission;
a third rotatable shaft aligned parallel to the main axis;
a first variator assembly having a first traction ring assembly and a second traction ring assembly in contact with a first plurality of balls, wherein each ball of the first plurality of balls has a tiltable axis of rotation, the first variator assembly is coaxial with the main axis, and the first traction ring assembly is coupled to the second rotatable shaft;
a second variator assembly having a third traction ring assembly and a fourth traction ring assembly in contact with a second plurality of balls, wherein each ball of the second plurality of balls has a tiltable axis of rotation, the second variator assembly is coaxial with the main axis, and the third traction ring assembly is coupled to the second traction ring assembly;
a first planetary gearset having a first sun gear coupled to the second rotatable shaft, a first planet carrier operably coupled to the first rotatable shaft, and a first ring gear coupled to the fourth traction ring assembly;
a second planetary gear set arranged coaxial with the third rotatable shaft, the second planetary gear set having a second sun gear, a second ring gear, and a second planet carrier operably coupled to the first rotatable shaft;
a third planetary gear set arranged coaxial with the third rotatable shaft, the third planetary gear set having a third sun gear, a third ring gear, a third planet carrier that is grounded;
a forward clutch positioned coaxial with the third rotatable shaft and operably coupled to the second sun gear and the third sun gear; and
a reverse clutch operably coupled to the second sun gear and the third sun gear.

2. The continuously variable transmission of claim 1, further comprising a first gear set coupled to the first rotatable shaft and the second planet carrier.

3. The continuously variable transmission of claim 2, further comprising a second gear set coupled to the second rotatable shaft and the second ring gear.

4. The continuously variable transmission of claim 3, further comprising a third gear set coupled to the second sun gear and the reverse clutch.

5. The continuously variable transmission of claim 4, further comprising a fourth gear set coupled to the reverse clutch and the third sun gear.

6. The continuously variable transmission of claim 5, wherein the forward clutch is a synchronizer clutch.

7. The continuously variable transmission of claim 6, wherein the reverse clutch is a synchronizer clutch.

8. The continuously variable transmission of claim 7, further comprising a final drive gear operably coupled to the third ring gear.

9. The continuously variable transmission of claim 1, wherein the variator comprises a traction fluid.

10. A vehicle driveline comprising: a power source, a variable transmission of claim 1 drivingly engaged with the power source, and a vehicle output drivingly engaged with the variable transmission.

11. The vehicle driveline of claim 10, wherein the power source is drivingly engaged with the vehicle output.

12. A vehicle comprising the variable transmission of claim 1.

13. A method comprising providing a variable transmission of claim 1.

14. A method comprising providing a vehicle driveline of claim 10 or 11.

15. A method comprising providing a vehicle of claim 12.
